(19) United States
(12) Patent Application Publication
(10) Pub. No.: US 2010/0213774 A1
(43) Pub. Date: Aug. 26, 2010

(54) Machines of imbalanced and gravitating magnetic bases

(76) Inventor: Ezra Shimshi, Atlanta, GA (US)

Correspondence Address: EZRA SHIMSHI, P.O. BOX 421011, ATLANTA, GA, 30342, US

(21) Appl. No.: 12/378,849

(22) Filed: Feb. 20, 2009

(51) Int. Cl. H02K 37/00; H02N 11/00

(52) U.S. Cl. 310/46; 74/DIG. 9

(57) ABSTRACT

The present invention makes it practical and easy to build machines of imbalanced and gravitating magnetic bases by using sets of magnetic bases with On/Off switches, which are adapted to revolve with horizontal spindle on a vertical plane as they achieve the intended imbalance through the lifting of weights when the magnetism of the magnetic bases are switched to “ON” and “OFF” at the vertical line zone and cause the magnetic bases to rotate.

### BACKGROUND OF THE INVENTION

a) Field Of The Invention

The present invention relates to machines that can supply independent, reliable and useable energy.

b) The Prior Art

There are no machines that could supply independent, reliable and useable energy as this instant invention can provide. Magnetic bases, mentioned herein, refer to the prior art of magnetic bases with On/Off switches, or N/S switches, which have unique, novel, and practical use in the present invention.

### SUMMARY OF THE INVENTION

The present invention introduces unique and novel source of energy supply. One embodiment of this invention comprises magnetic bases with On/Off switches rotating about axis of rotation. The magnetism of the magnetic bases can be switched to “On”, or to “Off”, every time they are about ninety degrees angle of a pulling force. The switch from magnetic element to non-magnetic element, back and forth, can produce the intended imbalance, which would cause the magnetic bases to rollover and rotate.

### BRIEF DESCRIPTION OF THE DRAWING

The present invention will be more readily understood by reference to the following description, taken with the accompanying drawings, in which:

FIG. 1A is a front view and it shows the inner magnetic bases with On/Off switches after having been forced to jump-up with their respective weights when the top magnetic bases are switched to “ON” and the bottom magnetic bases are switched to “OFF”.

FIG. 1B is the same as FIG. 1B, but it shows the inner and the outer magnetic bases after 180 degrees rollover and just before the inner magnetic bases jump-up.

FIG. 2 is a front view showing four magnetic bases fixed to a ring, which is adapted to rotate about axis of rotation. Similar to FIG. 1A, the respective weights jump-up when the top magnetic base turns “ON” and the bottom magnetic base turns “Off”.

FIG. 3 is simpler version of the present invention and it shows only two magnetic bases with On/Off switches revolving with their spindle, which is responsive to magnetism, and before said magnetic bases jump-up.

FIG. 4 is the same as FIG. 3, but after the respective magnetic bases jumped-up and, also, an additional pair of two magnetic bases are seen, which are positioned in 90 degrees angle to the other two magnetic bases.

FIG. 5 is another version of the present invention and it shows two units with their spindle connected and each unit has magnetic base with N/S switch, which is also the spindle. Here, two permanent magnets are seen, which are adapted to revolve with said magnetic-base/spindle.

### DESCRIPTION OF THE EMBODIMENT

Parts in the embodiments and their designated numbers in the drawings are: Magnetic base 6; Switch 7; Trigger 8; Guider 9; Spindle 10; Stand 11; Permanent magnet 12; Vertical-line 20.

The invention may be implemented in a wide range of embodiments, each adapted to be able to carry a load such as running a generator, for example, in order to maintain an effective rate of rotation and steadiness of speed.

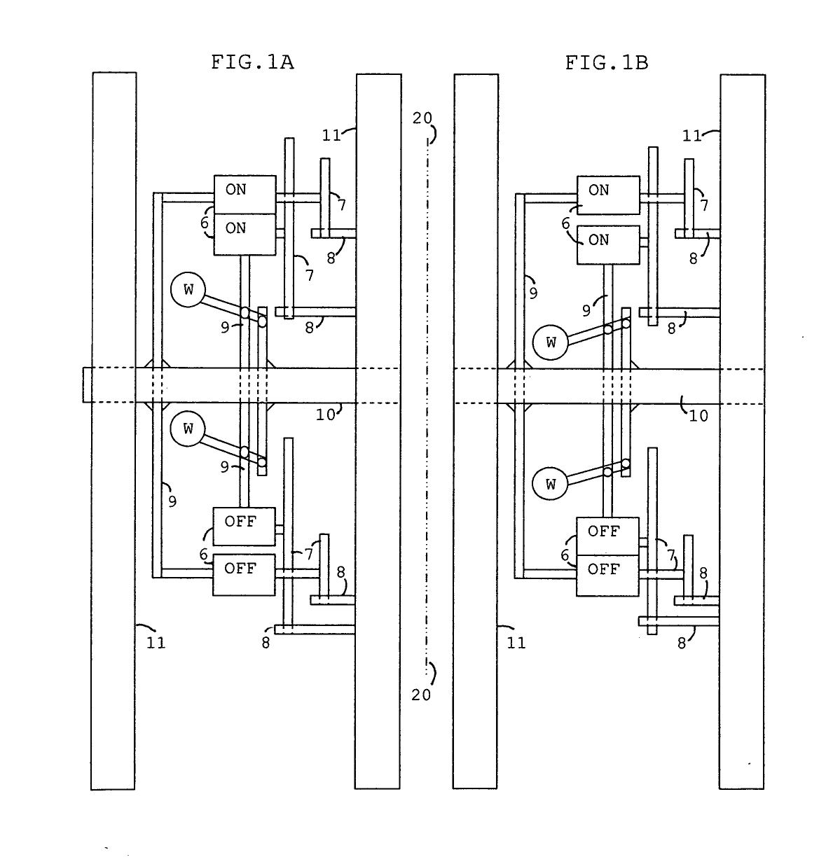

Referring to FIG. 1A, thereof, the four magnetic bases 6 are adapted to rotate with the horizontal spindle 10 on a vertical plane. The spindle 10 is held by stands 11. The two outer magnetic bases 6 are fixed to spindle 10 by guider 9. The two inner magnetic bases 6 are connected by guider 9 and can slide through spindle 10. When the magnetic bases 6 cross the vertical-line 20, the top triggers 8 turn the top switches 7 to “ON” position and the bottom triggers 8 turn the bottom switches 7 to “OFF” position. The pulling forces of the top magnetic bases 6 lift up the inner magnetic bases 6 and any other respective weights, which create imbalance. This imbalance causes the magnetic bases 6 to rollover. As soon as the rollover of the magnetic bases 6 is completed the On/Off switches change positions and another rollover occurs. The weights of the outer magnetic bases 6 may be utilized to lift the other weights, as said magnetic bases 6 move down, by having their guider 9 slide through spindle 10 and the inner guider 9 fixed to spindle 10.

FIG. 1B shows the inner magnetic bases 6 just before they jump-up after completing 180 degrees rollover from the position of the magnetic bases 6 seen in FIG. 1A.

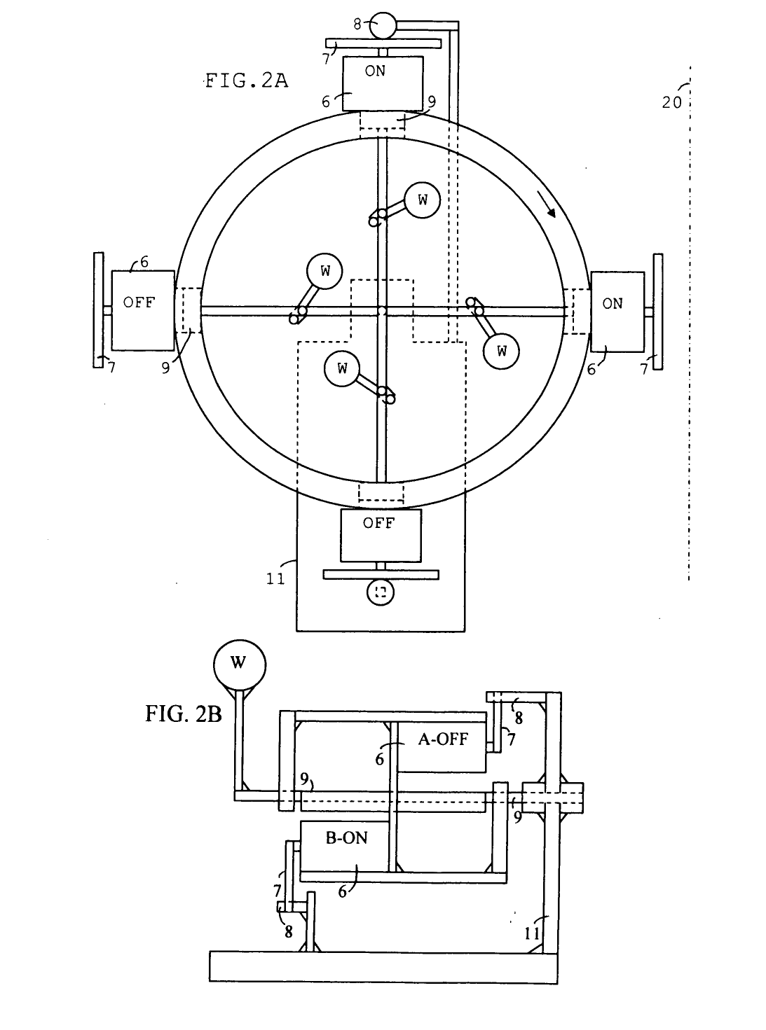

FIG. 2 may be more practical embodiment of the present invention. The magnetic bases are fixed to a rotating ring and the ends of each guider can be placed as closed as needed to the respective magnetic bases to be lifted and still create an effective imbalance through levers with weights.

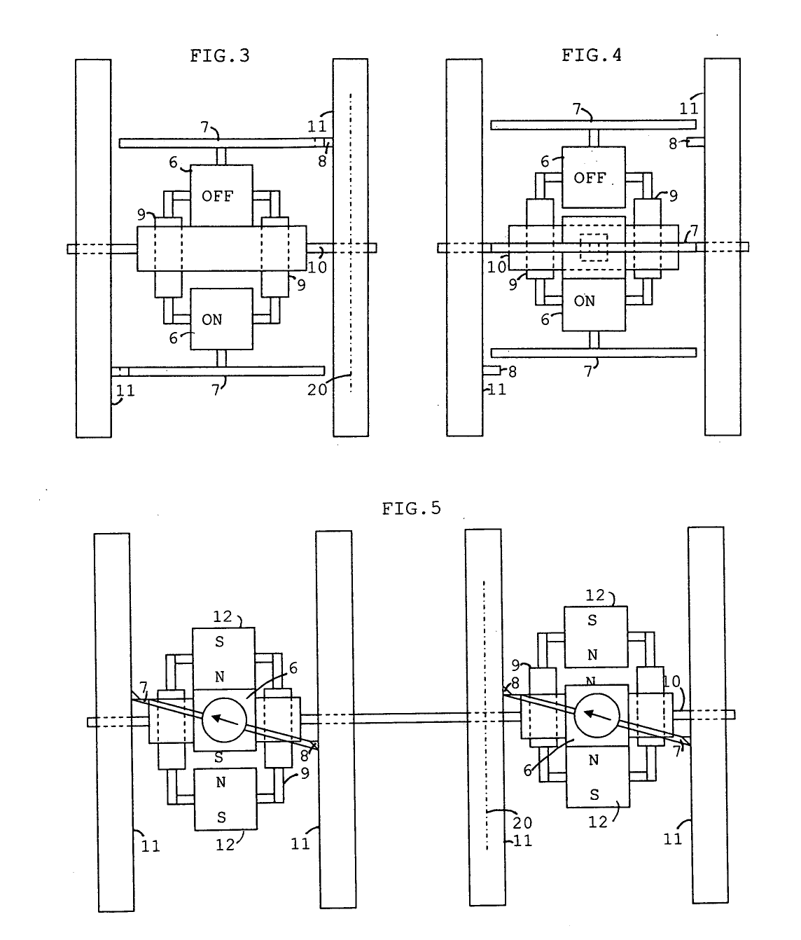

FIG. 3 is simpler version of the present invention. Here, the large diameter of spindle 10 serves as the pulling object for the bottom magnetic base 6. The magnetic bases 6 are seen just before they jump-up.

FIG. 4 is similar to FIG. 3, but with an additional pair of magnetic bases 6 in horizontal position of 90 degrees angle to the other pair of the magnetic bases 6. The respective magnetic bases 6 are seen after they have jumped-up.

FIG. 5 shows two similar units complementing each other by making it possible for the pair of permanent magnets 12 in one unit to be positioned at 90 degrees angle to the other pair of permanent magnets 12 in the other unit. The emphasis, however, is to show the combination of pull and push that drives each pair of the permanent magnets 12, upwards. Each magnetic base 6 is also the spindle 10 of its unit and it has a N/S switch. Every 180 degrees rollover the magnetic base 6 changes its poles from “NORTH” to “SOUTH”, and back, so that the bottom permanent magnet 12 always confronts an opposite magnetic pole and the upper permanent magnet 12 always confronts the same magnetic pole so as to have two combined forces that can, drive the permanent magnets 12, upward.

Other embodiments of the present invention can include other means to create more effective imbalance and include any number of sets of one, two, or four, magnetic bases, and/or permanent magnets, revolving with a single spindle, shaft, or ring, in order to carry greater load and maintain steadiness of rotational speed. The respective switches may be turned by various means, whether mechanical or electrical. The magnetism of the respective magnetic bases may be natural, manufactured, or electromagnetic. The lifting of the respective weights may be accomplished by various means. Other embodiments of the present invention may have means for increasing imbalance as the respective magnetic bases do the heavy lifting.

While this invention has been described with reference to the mechanism disclosed herein, it is not confined to the detail as set forth and is not intended in any way to limit the broad features or principles of the present invention, or the scope of patent monopoly to be granted. This application is intended to cover any modification or changes that may come within the scope of the following claims.

I claim:

1. Energy machine, comprising:
(a) Magnetic bases with On/Off switches revolving about axis of rotation on a vertical plane;
(b) Means for enabling the magnetic bases to maintain a predetermined imbalance in the energy machine so as to cause the magnetic bases to rotate in one direction;
(c) Means for maintaining effective rate of rotation and steadiness of speed.

2. The energy machine as in claim 1, wherein the means for enabling the magnetic bases to maintain a predetermined imbalance in the energy machine so as to cause the magnetic bases to rotate in one direction, comprising:
(a) Weights;
(b) Means for switching the magnetism of the magnetic bases to “ON” and “OFF”;
(c) Means for causing the weights to be lifted by the magnetic bases so as to create the predetermined imbalance.

3. A method in which magnetic bases with On/Off switches are used to supply energy, including the steps:
(a) Having magnetic bases with On/Off switches free to rotate on a vertical plane;
(b) Enabling the magnetic bases to maintain imbalance when the magnetism of said magnetic bases is switched to “ON”, or to “OFF”, when they cross a vertical line;
(c) Switching to “On”, or to “OFF”, the magnetism of said magnetic bases when they cross said vertical line.

4. The unique and novel use of magnetic bases with On/Off switches for the practical and useable purpose of converting magnetism to rotary energy, comprising:
(a) Magnetic bases rotating about axis of rotation on a plane parallel to a pulling force;
(b) Weights;
(c) Means for enabling the magnetic bases to drive the weights so as to maintain effective rotation for the magnetic bases.

5. The unique and novel use of magnetic bases with On/Off switches as in claim 4, wherein the means for enabling the magnetic bases to drive the weights so as to maintain effective rotation for the magnetic bases, comprising:
(a) Triggers, adapted to switch the magnetism of the magnetic bases from “ON” to “OFF” and from “OFF” to “ON”;
(b) Means for making it possible for the magnetic bases to move heavier weights as necessary for the conversion of the magnetic forces into the required rotational energy.
